(19) United States
(12) Patent Application Publication
(10) Pub. No.: US 2002/0047540 A1
(43) Pub. Date: Apr. 25, 2002

(54) Radio frequency ion plating apparatus

(75) Inventors: Hiroharu Fujita, Saga-shi (JP); Masahiro Mori, Gotemba-shi (JP); Shiro Kaga, Gotemba-shi (JP); Masaharu Tashiro, Gotemba-shi (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: OCJ/OPTICAL COATING JAPAN

(21) Appl. No.: 09/879,053

(22) Filed: Jun. 13, 2001

(30) Foreign Application Priority Data
Jun. 13, 2000 (JP) 2000-176709

(51) Int. Cl. H05B 31/26

(52) U.S. Cl. 315/111.21

(57) ABSTRACT

A radio frequency ion plating apparatus in which an evaporation source 10 and rotational electrode 2 holding substrate are disposed in a vacuum chamber having suitable gas introduced therein, radio frequency power is supplied through a mechanical contactor 3, an ion in plasma generated in a radio frequency discharge space causes a film surface on a substrate to bombard by dc bias voltage generated at the rotational electrode holding substrate. Within the vacuum chamber is disposed auxiliary electrode 9 for producing plasma to which is supplied radio frequency power separately from radio frequency power supplied to rotational electrode 2 holding substrate.

Two radio frequencies supplied to the rotational electrode holding substrate and the auxiliary electrode, respectively, are used with different frequency and or different power.

### BACKGROUND OF THE INVENTION

1. Field of the Invention

The present invention relates to a radio frequency ion plating apparatus for supplying radio frequency electric power to an electrode holding substrate provided within a vacuum chamber, and applying ion bombardment to a film during evaporation making use of plasma generated by radio frequency discharge and induced a dc voltage.

2. Description of the Related Art

In a radio frequency ion plating apparatus making use of ion in plasma generated by supplying radio frequency power between a substrate and an evaporated source provided within a vacuum chamber, it is, needless to say, necessary to maintain stability of radio frequency discharge within a vacuum chamber contributed to plasma producing caused by a supply of radio frequency power and generation of dc bias voltage.

However, generally, for improving quality of evaporated film, a vacuum pressure at the ion plating is approximately 10⁻² Pa, which is pressure lower by one figure than a vacuum pressure of a plasma generator for usual use, and for making an amount of evaporation on the substrate even, rotation is imparted to the electrode holding substrate. However, it is difficult to maintain stability of radio frequency discharge due to the fact that variation of contact resistance resulting from rotation of a mechanical contactor occurs, and that matching adjustment of radio frequency discharge corresponding to a change in impedance of a discharge circuit caused by a change of dielectric constant resulting from an increase in film thickness adhered to the surface of an electrode holding substrate or resulting from a kind of evaporated material in an evaporated space when a dielectric is evaporated poses a considerably delicate problem.

### SUMMARY OF THE INVENTION

The present invention is to provide a radio frequency ion plating apparatus, which fulfills the request noted above, which facilitates generation and maintenance of plasma despite low vacuum pressure, and which enables generation of sufficient dc bias voltage.

According to the present invention, there is provided a radio frequency ion plating apparatus in which an evaporation source is disposed, radio frequency power is supplied through a mechanical contactor to thereby generate radio frequency discharge, and ion in plasma generated in a discharge space causes to bomberd against the film surface on a substrate by dc bias voltage generated between rotational electrodes holding substrate, and discharge space characterized in that an electrode (hereinafter referred to as an auxiliary electrode) is disposed for producing plasma to which is applied radio frequency power of frequency f2 separately from radio frequency power of frequency f1 supplied to the rotational electrode holding substrate.

Preferably, at this time, two radio frequencies supplied to the rotational electrode holding substrate and the auxiliary electrode, respectively, are used by different frequency or different power.

### BRIEF DESCRIPTION OF THE DRAWING

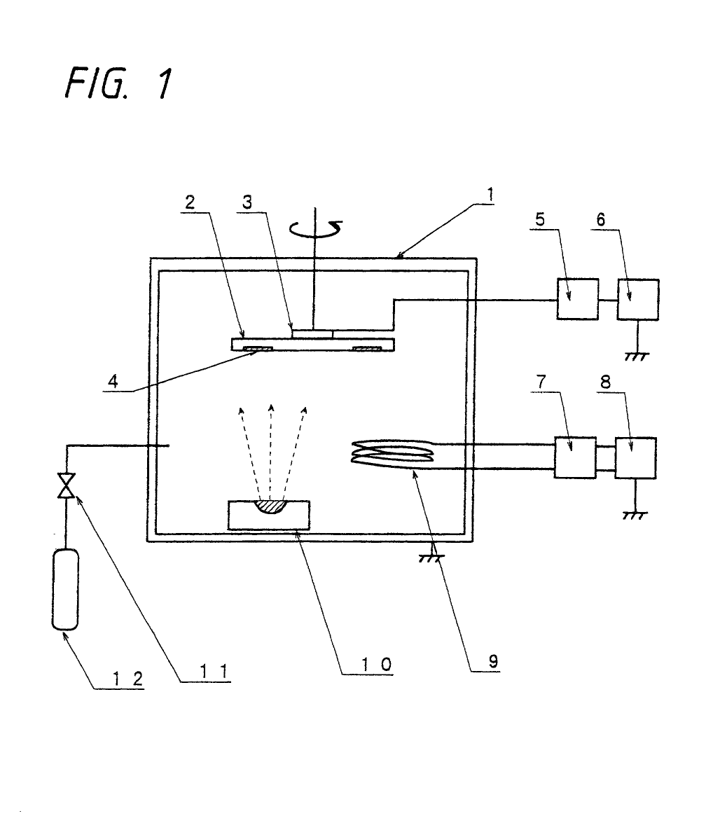

A single figure (FIG. 1) is a conceptual view showing one embodiment of the constitution of a radio frequency ion operating apparatus according to the present invention.

### DESCRIPTION OF THE PREFERRED EMBODIMENTS

The embodiment will be described in detail.

Referring to FIG. 1, reference numeral 1 designates a vacuum chamber, within which are disposed a rotational electrode 2 for holding substrate 4 and evaporation source 10, similarly to prior art. Radio frequency power of frequency f1 supplied from a power supply 6 to the rotational electrode 2 holding substrate through a matching network 5 and a mechanical contactor 3 is introduced into the vacuum chamber 1, after having been exhausted to high vacuum in advance, predetermined reaction gas (for example, oxygen gas for evaporation of an oxide film) through an introducing gas adjusting valve 11 so as to have predetermined pressure from a gas cylinder 12. The vacuum chamber 1 is connected to, for example, a cryopump to maintain at a predetermined vacuum pressure.

In the radio frequency ion plating apparatus according to the present invention, an auxiliary electrode 9 is independently disposed internally of the vacuum chamber 1 separately from the rotational electrode 2 holding substrate, and radio frequency power of frequency f2 is supplied through the matching network 7 from a power supply 8 for the auxiliary electrode separately from the power supply 6 of frequency f1 for the rotational electrode 2 holding substrate.

By the provision of the constitution as described above, the rotational electrode holding substrate and the auxiliary electrode receive a supply of individual radio frequency power different in frequency from each other, and stabilized radio frequency discharge can be obtained in the vacuum chamber by suitable gas introduced into the vacuum chamber and the auxiliary electrode directly connected to the power supply.

In the actual discharge experiments, in Pₒ₂=2.7×10⁻² Pa and in f1=500 kHz and f2=13.56 MHz, the stabilized discharge was obtained. Conversely, in f1=13.56 MHz and f2=500 kHz, the stabilized discharge failed to obtain. Further, in f1=13.56 MHz and f2=13.56 MHz, the matching could not be adjusted to fail creation of the stabilized discharge.

This is because of the fact that the plasma produced by the discharge of the auxiliary electrode 9 causes a main discharge to be maintained stably by diffusing ion within a main discharge area of the rotational electrode holding substrate. A part of reaction gas or a part of vapor from the evaporation source 10 is ionized within the main discharge.

DC bias voltage induced on the rotational electrode holding substrate accelerates ion in the plasma generated as described above to bomber against a film on the substrate installed on the rotational electrode holding substrate.

By impeding the crystal growth of a film and the generation of a void, it became possible to form an amorphous thin film which has radio density and is stable.

While in the above-described embodiment, the auxiliary electrode 9 uses a radio frequency coil to generate an inductively coupled plasma, it is noted that a capacitive coupling electrode may be used instead of the inductive coupling as described above.

Further, while in this example, the auxiliary electrode 9 is disposed internally of the vacuum chamber 1, it is noted that the auxiliary electrode 9 may be disposed within a separate chamber connected to the vacuum chamber 1 in order to avoid the contamination caused by sputtered auxiliary electrode material or the change in impedance by film adhesion to surface of an electrode.

As the evaporation source 10, suitable sources such that evaporation material such as metal oxide is evaporated by electron-beam heating, or is heated and evaporated by electric heating can be used.

Further, it is desired that in two radio frequencies supplied to the rotational electrode holding substrate and the auxiliary electrode, respectively, the frequency of different frequency and/or different power, concretely, radio frequency power supplied to rotational electrode holding substrate is lower than the radio frequency power supplied to the auxiliary electrode, but needless to say, such can be suitably selected according to the evaporation condition.

For forming an optical thin film, a thin film of tantalum oxide was evaporated and formed on the glass substrate.

Oxygen gas was introduced into the vacuum chamber 1 exhausted to 10⁻⁴ Pa in advance by the introducing gas adjusting valve 11 so as to have a vacuum pressure of 2.7×10⁻² Pa. As the evaporation source, Ta₂0₅ as evaporation material was evaporated by an electron beam and evaporated at a substrate temperature of 200° C. To the rotational electrode 2 holding substrate was supplied radio frequency power of frequency 500 KHz and output 120 W through the matching network 5 from the power supply 6, and to the auxiliary electrode 9 was supplied radio frequency power of frequency 13.56 MHg and output 1.5 KW through the matching network 7 from the power supply 8. Despite of low pressure of the vacuum chamber, the plasma was easily generated, and stabilized during evaporation.

The thin film obtained by the above-described constitution showed a high refractive index, 2.25 (550 nm) with respect to refractive index, 2.00 of a thin film obtained by an evaporation method not using ion bombardment. Further, no change in spectral transmittance was observed also with respect to the constant temperature and constant humidity test (85° C., 85%RH, and 2000 hours) of the obtained film.

As described above, in the radio frequency ion plating apparatus of the present invention, the auxiliary electrode maintains the plasma stably by radio frequency power supplied thereto, and different radio frequency power for ion accelerating is supplied to the electrode holding substrate, whereby deep dc bias voltage was induced to increase bombardment of ion to the evaporated film, thus enabling obtaining an evaporated film of radio quality.

As described above, radio frequency power for generating plasma and radio frequency power for generating dc bias voltage creating ion bombardment on the substrate are maintained optimally therefor to thereby realize the wide and optimum evaporation condition with respect to a different substrate and a different evaporation material.

What is claimed is:

1. In radio frequency ion plating apparatus in which in a vacuum evaporation having suitable gas introduced, radio frequency power is supplied to a rotational electrode holding substrate provided in a vacuum chamber through a mechanical contactor, and ion in plasma generated by radio frequency discharge causes to bombard a film surface on a substrate by dc bias voltage generated at the rotational electrode holding substrate, characterized in that there is disposed an auxiliary electrode for producing plasma to which is supplied radio frequency power separately from radio frequency power supplied to said rotational electrode holding substrate.

2. The radio frequency ion plating apparatus according to claim 1 wherein two radio frequencies supplied to said rotational electrode holding substrate and said auxiliary electrode, respectively, are used with different frequency and different power.

3. The radio frequency ion plating apparatus according to claim 2 wherein the frequency supplied to said rotational electrode holding substrate is lower than the frequency supplied to the auxiliary electrode.

4. The radio frequency ion plating apparatus according to claim 2 wherein the auxiliary electrode is disposed in a vacuum chamber.

5. The radio frequency ion plating apparatus according to claims 4 wherein the frequency supplied to said rotational electrode holding substrate is lower than the frequency supplied to the auxiliary electrode.

6. The radio frequency ion plating apparatus according to claim 2 wherein the auxiliary electrode is disposed in a separate chamber connected to the vacuum chamber.

7. The radio frequency ion plating apparatus according to claim 6 wherein the frequency supplied to said rotational electrode holding substrate is lower than the frequency supplied to the auxiliary electrode.

8. The radio frequency ion plating apparatus according to claim 1 wherein the frequency supplied to said rotational electrode holding substrate is lower than the frequency supplied to the auxiliary electrode.

9. The radio frequency ion plating apparatus according to claim 8 wherein the auxiliary electrode is disposed in a vacuum chamber.

10. The radio frequency ion plating apparatus according to claim 1 wherein the auxiliary electrode is disposed in a vacuum chamber.

11. The radio frequency ion plating apparatus according to claim 1 wherein the auxiliary electrode is disposed in a separate chamber connected to the vacuum chamber.

12. The radio frequency ion plating apparatus according to claim 11 wherein the frequency supplied to said rotational electrode holding substrate is lower than the frequency supplied to the auxiliary electrode.
